(19) United States
(12) Patent Application Publication
(10) Pub. No.: US 2020/0060931 A1
(43) Pub. Date: Feb. 27, 2020

(54) CONTAINER FOR COMPOSITIONS AND METHODS FOR STORING, TRANSPORTING, DISPENSING AND DISTRIBUTING COMPOSITIONS IN SUCH CONTAINERS

(71) Applicant: Jeffery Michael Carrico, Washington, DC (US)

(72) Inventor: Jeffery Michael Carrico, Washington, DC (US)

(21) Appl. No.: 16/547,353

(22) Filed: Aug. 21, 2019

Related U.S. Application Data
(60) Provisional application No. 62/768,010, filed on Nov. 15, 2018.
(60) Provisional application No. 62/720,606, filed on Aug. 21, 2018.

(51) Int. Cl. A61J 1/00; B65D 3/24; B65D 3/26; B65D 79/02; G01N 29/24

(52) U.S. Cl. CPC A61J 1/00; B65D 3/24; B65D 3/26; B65D 79/02; G01N 2291/02881; B65D 2585/56; A61J 2200/72; B65D 2201/00; G01N 2291/02845; G01N 29/2481

(57) ABSTRACT

A container for a pharmaceutical composition in which the container has a cover, and a cavity holding a sensor capable of detecting temperature and/or humidity. The sensor is capable of detecting when conditions of temperature and/or humidity fall outside of predetermined ranges. The sensor is further capable of sending a signal to a receiver outside of the container indicating the present or historical conditions of temperature and/or humidity.

### BACKGROUND

This disclosure relates to containers for pharmaceutical (medications and drugs) and other compositions, and methods for storing, transporting, dispensing and distributing pharmaceutical or other compositions in such containers.

This invention relates to containers used for storing, transporting, dispensing and distributing pharmaceutical and other compositions, especially sensitive pharmaceutical compositions that can be compromised under certain conditions, including temperature and/or humidity conditions.

Pharmaceutical compositions are stored, transported, dispensed and distributed through many channels including by manufacturers, formulators, packagers, pharmacies, hospitals, organizations conducting clinical trials, research organizations, medical aid organizations, first responders, emergency relief organizations, remote healthcare units, patients, and their caregivers. Many pharmaceutical compositions must be maintained under certain conditions, including temperature and/or humidity, and must be used within a certain time period or their effectiveness or potency can be compromised or they expire. This can be particularly important for drugs that are expensive, are critical for treatment of health conditions, and/or are in a form that requires special handling other than ambient conditions, but does not exclude medications stored in ambient conditions.

There is a need in the art for containers that can be used to store, transport, dispense and distribute pharmaceutical compositions that track conditions such as temperature and/or humidity and notify handlers and users (either in real time or at a later time) when a pharmaceutical composition has been exposed to conditions outside of defined ranges.

There is a further need to ensure patients have access to pharmaceutical compositions that have been maintained under conditions that preserve their efficacy, potency, and safety and that pharmacy and healthcare workers, patients and/or caregivers are notified when pharmaceutical compositions have been exposed to conditions outside defined parameters.

There is also a need to provide cost effective containers and systems for protecting pharmaceutical compositions from unsuitable conditions and providing those compositions efficiently while ensuring the pharmaceutical compositions are of consistent quality.

There is also a need for containers that make administration of pharmaceutical compositions more convenient, particularly liquid oral dosage forms and powder oral dosage forms that need to be measured for administration of a suitable dosage to a patient.

There is also a need for containers for use in a wide variety of applications that contain a component for dosing or measuring.

### SUMMARY OF THE INVENTION

In one embodiment, the present invention is directed to a pharmaceutical container that is provided with a section defining a cavity in which a sensor is placed for detecting conditions. Preferably the sensor can be removed from and replaced in the cavity. Alternatively, the sensor is fixed in the cavity in the container. The conditions monitored by the sensor preferably include temperature and/or humidity. In a further preferred embodiment, the sensor records and/or sends a signal that indicates the present or historical conditions of the pharmaceutical composition in the container.

In another embodiment, the invention is a container having a cap that is removably attached to the container that can be used to administer an oral liquid or powder pharmaceutical composition to a patient. In another embodiment, the invention is a container having a cap that is removably attached to the container that can be used to dose or measure the material in the container or a composition containing the material in the container. This container eliminates the need for a separate dosing spoon or cup and provides convenience for a patient or end user.

### BRIEF DESCRIPTION OF THE DRAWINGS

FIG. 1 is a side view of one embodiment of a container with a cap according to the present invention.

FIG. 2 is a side view of a cross section of one embodiment of a container according to the present invention.

FIG. 3 is an alternate view of one embodiment of a container of the present invention.

FIG. 4 is a side view of one embodiment of a container with a cap according to the present invention.

FIG. 5 is a cross section of a side view of one embodiment of a container with a cap according to the present invention.

FIG. 6 is a side view of one embodiment of a container and a cap according to the present invention.

FIG. 7 is a cross section of a side view of one embodiment of a container and a cap according to the present invention.

FIG. 8 is a top view of one embodiment of a container of the present invention.

FIG. 9 is a side view of a dosing cap according to the invention.

FIG. 10 is an alternate view of a dosing cap according to the invention.

FIG. 11 is an alternate view of a dosing cap attached to the top of a container for a pharmaceutical composition according to the invention.

FIG. 12 is an alternate view of a dosing cap attached to the top of a container for a pharmaceutical composition according to the invention.

FIG. 13 is a side view of a carabiner with extra clip according to another invention disclosed in this application.

FIG. 14 is a side and top view of one embodiment of a connector for connecting multiple containers or sets of containers together.

FIG. 15 is a side and top view of another embodiment of a connector for connecting multiple containers or sets of containers together.

FIG. 16 is a side and top view of one embodiment of a dosing spoon/measuring cup according to the invention, wherein the dosing spoon/measuring cup is integral with the cap of a bottle.

FIG. 17 is a side and top view of another embodiment of a dosing spoon/measuring cup according to the invention, wherein the dosing spoon/measuring cup is connected to the cap of a bottle by a hinge.

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein.

### DETAILED DESCRIPTION

In the drawings and description that follows, like parts are marked throughout the specification and drawings with the same reference numerals, respectively. The drawings are not necessarily to scale. Certain features of the invention may be shown exaggerated in scale or in somewhat schematic form and some details of conventional elements may not be shown in the interest of clarity and conciseness. The present invention is susceptible to embodiments of different forms. Specific embodiments are described in detail and are shown in the drawings, with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results. The various characteristics mentioned above, as well as other features and characteristics described in more detail below, will be readily apparent to those skilled in the art upon reading the following detailed description of the embodiments, and by referring to the accompanying drawings.

Pharmaceutical Container and Method of Storage, Transport, Dispensing and Distribution

In one embodiment, the present invention is directed to a pharmaceutical container that is provided with a section defining a cavity in which a sensor for detecting conditions is placed. Preferably the sensor can be removed from and replaced in the cavity. The conditions monitored by the sensor preferably include temperature and/or humidity. In a further preferred embodiment, the sensor records and/or sends a signal that indicates the conditions of the pharmaceutical composition in the container.

The pharmaceutical composition can be in any form including but not limited to capsules, caplets, tablets, liquids, oral solutions, oral suspensions, syrups, elixers, tinctures, emulsions, lozenges, troches, suppositories, enemas, transdermal patches, inhalation products, injectable forms (including liquid, lyophilized powders and powders), injectable forms in prefilled syringes, dissolvable films, intravenous liquids, ointments, chewable forms, topical products, ocular products, otic products, or any prepackaged form of such forms. The pharmaceutical composition can be a pharmaceutical active agent or combination of active agents, an active agent(s) formulated with excipients, a branded or generic drug, a biologic, insulin, specialty medication, investigational medicine, other medication used in clinical trials or research, a composition for human or veterinary administration, or any other composition for pharmaceutical purposes.

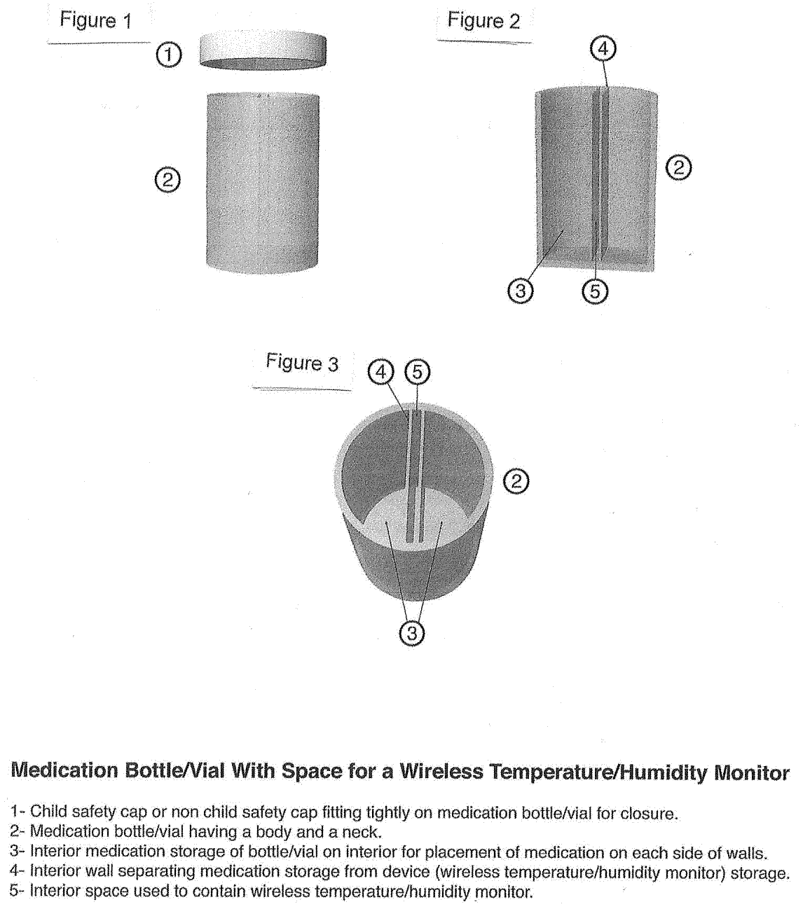

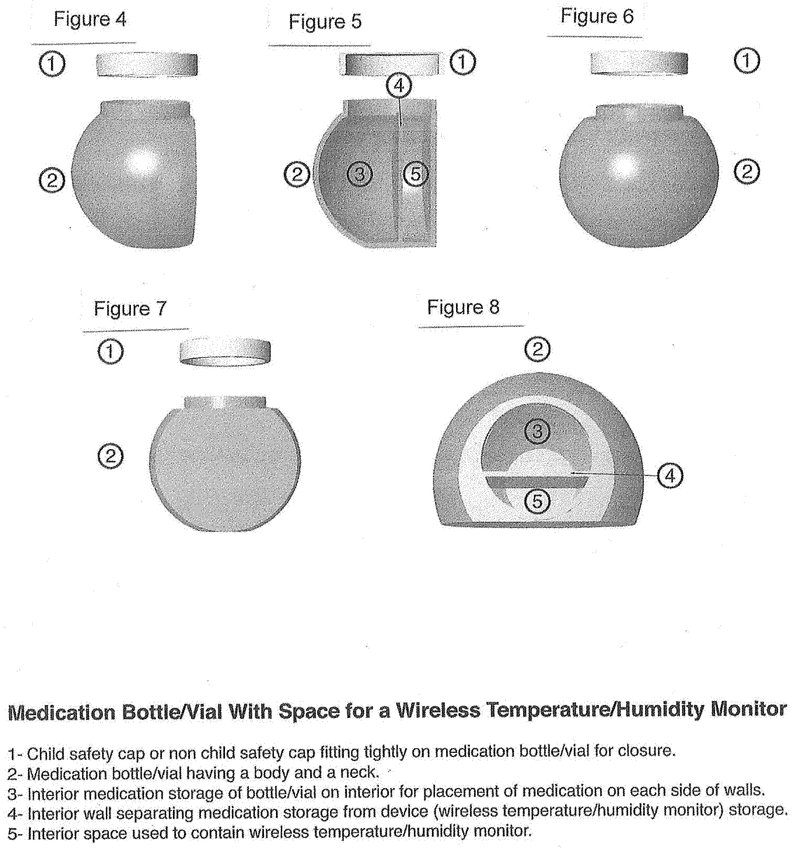

The container can be in any shape or size including conventional shapes available for pharmaceutical storage, transport, dispensing or distribution including but not limited to bottles, vials, canisters, crates and boxes. As an example, the container 2 and cover 1 can be of the shapes shown in FIGS. 1-8. The cavity for holding the sensor 5 and the area(s) for holding the pharmaceutical composition 3 can be located in the container in a variety of configurations, including those shown in FIGS. 2, 3, 5, and 8. The cavity for holding the sensor 5 and the area for holding the pharmaceutical composition 3 can be separated by a barrier 4. The cavity containing the sensor can optionally be covered by a solid or permeable cover, including a mesh or screen that contains the sensor in the cavity but allows exposure to conditions of the container and the pharmaceutical composition. The container can be made of any material suitable for holding a pharmaceutical composition, including but not limited to plastic, glass, and metal. The container can have the capacity to hold a single dosage unit, multiple dosage units, or multiple prepackaged dosages or multi-dosage units. The container may optionally have a flat surface as shown in FIGS. 5 and 8, which may have a magnet on the inner or outer surface of the flat surface for attaching the bottle to a surface such as a refrigerator, cabinet, locker, magnetic board, secure container or safe, or medical storage, transport, dispensing or distributing unit.

In a preferred embodiment, the container, as well as its cover or cap, are made of materials (as approved and accepted by the Food and Drug Administration (FDA) and United States Pharmacopeia (USP)) commonly used to manufacture medication vials/bottles and caps including, but not limited to, #1, #2 and #5 plastics (polyethylene terephthalate, high-density polyethylene, or polypropylene). These are representative examples, but not an exhaustive list, and any materials used to manufacture medication bottles/vials and caps may be used such as glass or other plastics as approved and accepted by the FDA and USP. The bottles/vials shall meet all definitions of a tight closure and meet applicable light standards for light transmission and protection of the product stored within.

The sensor can be any sensor capable of fitting into the cavity within the container. The sensor preferably can monitor and detect conditions of at least one or more of temperature, humidity, pressure, light, oxygen exposure, tampering, composition degradation, and/or time.

In a preferred embodiment, the sensor is a wireless temperature monitor or wireless humidity monitor that is inserted into a cavity in the container according to the invention as it is dispensed to the patient or shipped to the patient or provider. These monitors collect the temperature or humidity conditions and that information can be transmitted, downloaded and/or collected to ensure that the medication is or was kept under proper storage conditions. These designs provide the opportunity to extend the monitoring of vital environmental conditions into the time while the medication is in the patient's possession which is truly the last mile of the supply chain. This device establishes and extends the stability budget of a medication further, through the patient's possession.

In a particular embodiment, the container is the container given to the patient. Environmental conditions such as temperature and/or humidity are tightly monitored throughout the supply chain for medications during shipping and storage. However, once the medication is dispensed to the patient, these metrics are generally no longer monitored to a consistent degree. The temperature profile while the medication is with the patient is vital. With investigational medications and medications being used in clinical trials, the validity of the data, safety, efficacy and results may be compromised if the medication is not stored properly. With specialty medications, proteins, small molecules and any other medications with temperature restrictions for storage, the efficacy of the medication may be compromised if they are not stored properly. Many medications are also sensitive to humidity levels and the efficacy can be compromised as well. In both cases, the effectiveness of the medication may be lessened, providing a suboptimal result for the patient. The containers according to the present invention can reduce or eliminate the risk that medicine dispensed to a patient unknowingly becomes unusable due to exposure to unsuitable conditions.

Container Connector

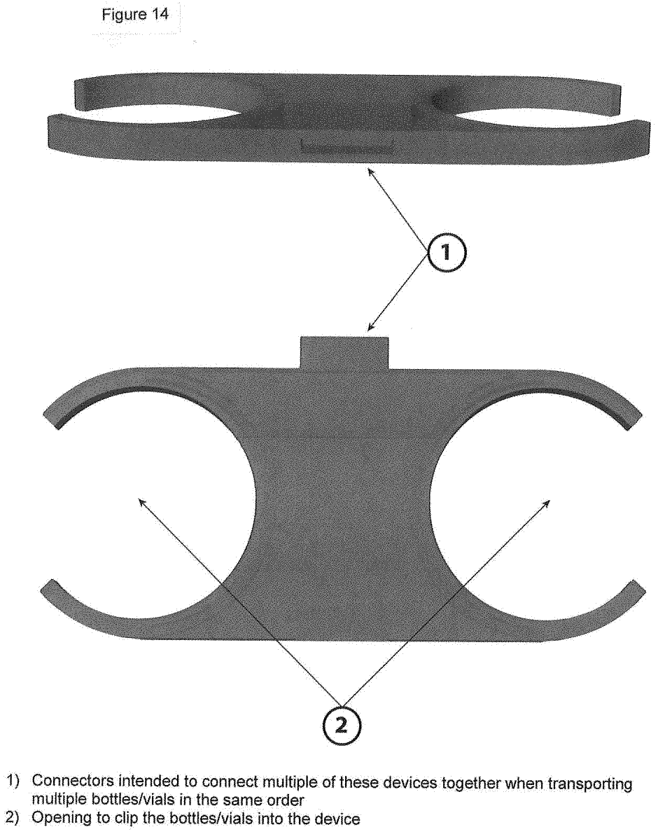

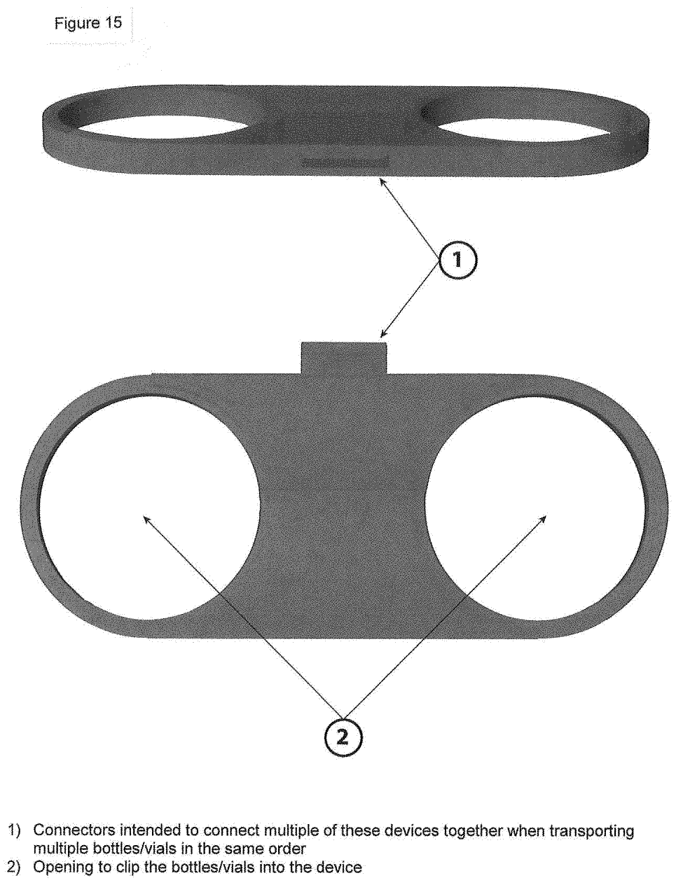

In another embodiment is a connector for holding two or more containers or sets of containers together. The connector has two or more openings into which the containers are inserted or clipped. For example, the openings can be partial or closed loops that fit the circumference of the containers. For example, FIG. 14 shows an example of a connector according to the invention wherein openings 2 in the shape of partial circles can hold the container or containers. FIG. 15 is an example of an embodiment in which the shape of the opening is a closed circle or loop. The connectors preferably contain a slot or tab 1, which fit together so that multiple connectors can be linked together and thereby connect multiple sets of containers. The connectors are particularly useful when transporting or storing multiple containers, such as bottles or vials, in the same shipment or order. The connector(s) can be used with any container that fits the shape of the opening (2), including but not limited to any embodiment of the pharmaceutical container according to the invention.

Dosing Spoon Combined with Medication Bottle Cap

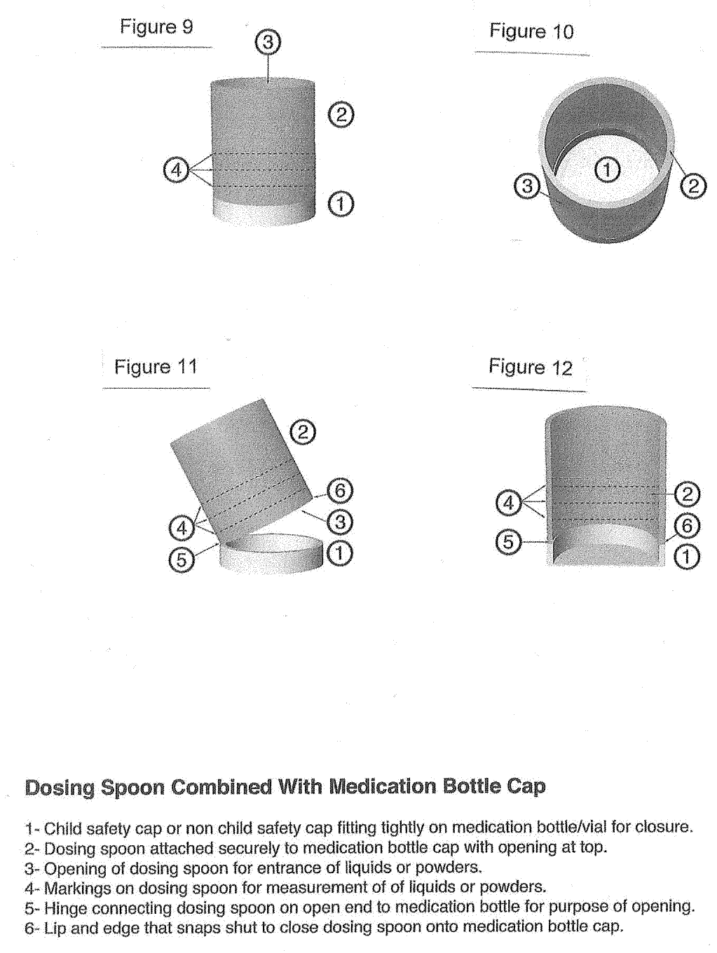

Dosing spoons are vital for the measurement of medications in the form of liquids and powders. As shown in FIGS. 9-12, two embodiments according to the invention combine/attach a dosing spoon to a medication vial/bottle cap for easy dispensing to a patient in need of a dosing spoon. These designs provide easier access and maintenance as the dosing spoon remains with the cap. One design has an outer opening and the other has an opening that closes onto the top of the cap and can be opened for use.

These designs will allow pharmacists and other healthcare providers the opportunity to order and dispense dosing spoons more easily. In addition, the dosing spoon will remain with the medication, making it easier for the patient to find and use the dosing spoon for more accurate measurement.

The dosing spoon may be used to dispense and administer liquid forms of medication (including, but not limited to suspensions and solutions) and powders. The cap with the dosing spoon may be used with a bottle intended for liquids or a bottle/vial intended for other dosage forms (to be kept by the patient and used when a dosing spoon is needed).

The cap and associated bottle/vial may be made of materials (as approved and accepted by the FDA and USP) commonly used to manufacture medication vials/bottles and caps including, but not limited to the following: #1, #2 and #5 plastics (polyethylene terephthalate, high-density polyethylene, or polypropylene). These are representative examples, but not an exhaustive list, and any materials used to manufacture medication bottles/vials and caps may be used such as glass or other plastics as approved and accepted by the FDA and USP. The bottles/vials shall meet all definitions of a tight closure and meet applicable light standards for light transmission and protection of the product stored within.

Dosing Spoon/Measuring Cup Combined with Bottle

In another embodiment, a container with a dosing spoon or measuring cup is disclosed. A common problem when handing a container of material, is the non-existence or lack of ability to conveniently locate a dosing spoon or measuring cup when needed. The combination product according to the invention has a dosing spoon and/or measuring cup attached to or integral with the cap for the container used in the primary packaging.

In one embodiment, the outer walls of the container's cap are extended upward to create the walls of the dosing spoon and/or measuring cup. Markings can optionally be included on the dosing spoon and/or measuring cup to indicate particular volume levels. For example, raised or printed markings can indicate different volume levels, e.g., 20 ml, 30 ml and 60 ml. In one embodiment, the top of the container's cap extends to form the dosing spoon and/or measuring device.

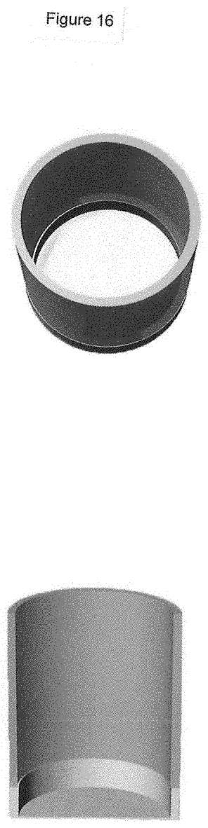

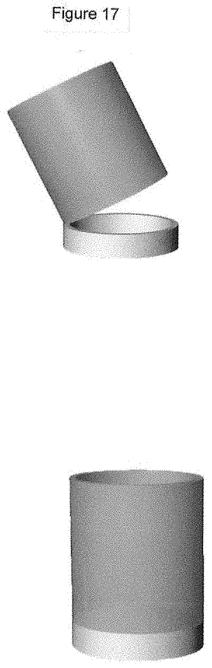

The dosing spoon and/or measuring device can be integral or immovably fixed to the container's cap, for example, as shown in FIG. 16. Alternatively, the dosing spoon/measuring cup is attached to the cap on one side by a hinge that keeps it connected but allows the measuring device to swing open, for example, as shown in FIG. 17.

There are many embodiments and applications for the dosing spoon and/or measuring cup according to the invention. For example, the dosing spoon and/or measuring cup and bottle combination can be used for liquid and powder forms of drug and vitamin/nutraceutical applications; pet and veterinary applications; liquid prescriptions and over the counter (OTC) medications; powder prescriptions and OTC medications; food and beverages; salad dressings; cooking and dipping oils, including canola oil, balsamic vinegar and olive oil; food flavorings and additives, including vanilla extract; powdered drink mixes, including sports and breakfast drinks; alcoholic beverages; and home and garden supplies, including cleaning supplies, bleach, detergents, pesticides, and weed killer.

The size of the bottle and dosing spoon/measuring cup, and the level of the markings for volume measurements on the dosing spoon/measuring cup can vary depending upon the substance to be measured and its use.

The cap, dosing spoon/measuring cup, and associated container may be made of any material or combination of materials commonly used to manufacture containers including but not limited to plastic, metal, glass, paper, or rubber.

Carabiner with Extra Clip in Order to Attach Hat or Other Items

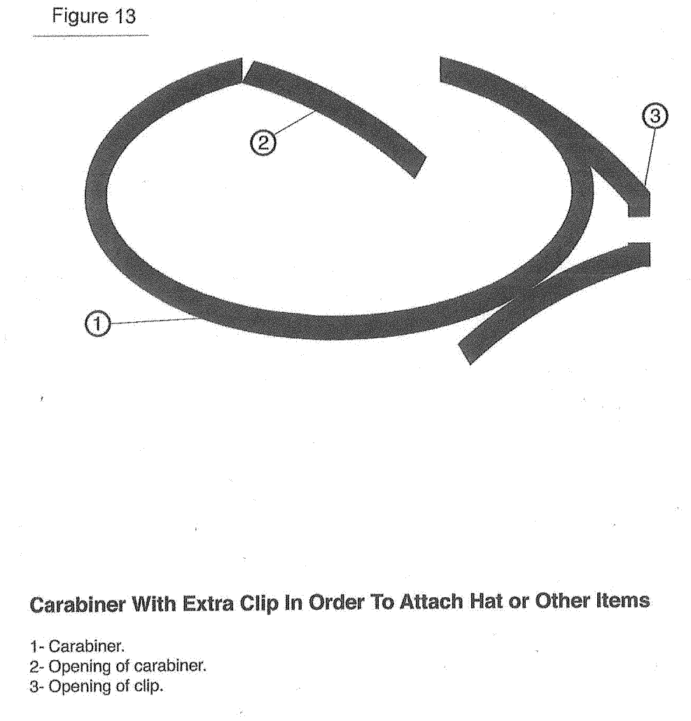

This application also discloses a carabiner that provides the opportunity to link two items together via a safety closure. This design places a clip 3 on the bottom of the carabiner 1 so that in addition to the safety closure 2 being attached to an object, a second object can be clipped for carrying and storage purposes. FIG. 13 is an example of an embodiment of the carabiner 1 with a closure 2 and an extra clip 3 for attachment to an object.

The material used to manufacture this product may be plastics of any form and/or metals of any form.

1. A container for a pharmaceutical composition, comprising:
a container with a cover,
wherein the container has a cavity holding a sensor capable of detecting temperature and/or humidity.

2. The container of claim 1, wherein the sensor is capable of detecting when conditions of temperature and/or humidity fall outside of predetermined ranges.

3. The container of claim 1, wherein the sensor is further capable of sending a signal to a receiver outside of the container indicating the present or historical conditions of temperature and/or humidity.
